(19) United States
(12) Patent Application Publication
(10) Pub. No.: US 2024/0286369 A1
(43) Pub. Date: Aug. 29, 2024

(54) COMPOSITE SKATE SHELL AND METHOD OF MANUFACTURING THEREOF

(71) Applicant: Warrior Sports, Inc., Shelby Township, MI (US)

(72) Inventors: Adam Gans, Prevost (CA); John Dekemp, Montreal (CA); Neal Watts, Montreal (CA)

(21) Appl. No.: 18/586,096

(22) Filed: Feb. 23, 2024

Related U.S. Application Data
(60) Provisional application No. 63/448,090, filed on Feb. 24, 2023.

(51) Int. Cl. B29D 35/14; A43B 5/16; B29D 35/00

(52) U.S. Cl. CPC B29D 35/146; A43B 5/1666; B29D 35/0063

(57) ABSTRACT

A method of manufacturing a portion of a boot shell for an ice skate that includes preparing a monolithic, two-dimensional pattern of the boot shell; positioning the monolithic, two-dimensional pattern into a three-dimensional preform of the boot shell; installing the three-dimensional preform in a mold; and consolidating the three-dimensional preform in the mold to produce the portion of the boot shell. An article of footwear for use in ice skating comprising a boot shell structured and arranged to accommodate a wearer's foot and having a medial forefoot portion, a lateral forefoot portion, a sole portion, a lateral ankle portion, a medial ankle portion, and a heel portion, the boot shell further comprising (i) a first thermoformable material having a softening point between 40° C. and 100° C., and (ii) a plurality of fibers, at least one of adjacent to or integrated within the first thermoformable material.

### CROSS-REFERENCE TO RELATED APPLICATION

This application claims priority to and the benefit of U.S. Provisional Patent Application No. 63/448,090, entitled “METHOD OF MANUFACTURING A COMPOSITE SKATE SHELL,” filed on Feb. 24, 2023, the entire contents of which are incorporated herein by reference.

### FIELD OF THE INVENTION

Embodiments of the present invention relate to a method of manufacturing a composite skate boot shell and, more particularly, to a manufacturing method using tailored fiber placement (TFP).

### BACKGROUND OF THE INVENTION

In skating, especially with ice hockey, lateral boot stiffness is required to support the wearer's foot. Hence, the industry has concentrated on the development of stiffer boot constructions, which, when using conventional materials, provide orthotropic stiffness characteristics, which is to say, equal stiffness in every direction. As boots become stiffer, however, the fit or comfort of the skate on the wearer's foot becomes less forgiving. As a result, conventionally, manufacturers have turned to methods of customizing the skate to the wearer's foot, thermoforming the materials about the discrete wearer's foot. Of necessity, due to the relatively high temperatures needed to soften the skate boot during thermoforming, materials that can be softened at lower temperatures are preferred.

The stiffer boots found in modern skates also present challenges specific to fit. Whereas previous boot designs produced from more flexible materials may have been pulled inward to follow the contours of the foot by pulling the laces inward (as with a traditional footwear), modern boots, made from less compliant materials are less capable of adjusting shape by tightening of the laces. For at least performance reasons, fit of a skate is very important. Therefore, it has become common practice to employ materials that allow for the boots to be heated and immediately thermoformed directly over the foot of the athlete.

A thermoforming temperature of 180° F. or lower is preferred as the boot may be placed directly on to the foot of the athlete without risk of injury due to the elevated temperatures.

Referring to FIGS. 1A and 1B, composite skate boot shells 100, traditionally, have been manufactured by assembling multiple layers 110, 120, 130, 140 of (e.g., relatively flat,) two-dimensional fabrics, attaching the fabric layers 110, 120, 130, 140 to one another, and forming the skate boot shell 100. Exemplary fibers for use in these fabrics may include: glass fibers, carbon fibers, fiberglass, natural fibers, plastic fibers, metallic fibers, and combinations thereof. By convention, before assembly, each fabric layer 110, 120, 130, 140 may be cut from larger fabric or material pieces or sheets. These sheets may include woven fibers alone (dry) or woven fibers embedded in a resin matrix. The cutting operation may be performed by hand or may involve using dies or a computer numerical control (CNC) process. Complex shapes allow the engineer to tailor performance and achieve a lighter weight boot. However, this often comes at the expense of higher material cutting losses. Hence, the cutting and nesting process is very important and labor intensive. A second disadvantage to the use of complex shapes is that orientation of one complex shape relative to the next can be challenging and time consuming. Therefore, the requirement for labor and skilled labor increases.

When assembled and attached to one another, the fibers of the fabric layers 110, 120, 130, 140 are typically oriented symmetrically relative to one another. For example, a typical weaving loom produces fabric with fibers in the warp (longitudinal) and weft (crossing) directions. The warp fibers typically run perpendicular to the weft fibers. Therefore, a typical fabric increases stiffness in a first axis and a second axis running perpendicular to the first. The weaver may choose to apply more fiber in the weft direction and less fiber in the warp direction (or vice-versa) to tailor stiffness properties. However, this may limit nesting capabilities and, therefore, further increase cutting losses during manufacturing. An engineer may also consider one-dimensional fabrics. However, these fabrics tend to be unstable due to the lack of crossing fibers to lock the fibers in place.

During the weaving process, the individual fibers may move back and forth and slide on top of each other. As such, it may be preferred for the surface of the fibers to be smooth and free of tack. Indeed, this is the case with raw fibers and typical co-mingled fibers produced with thermoplastics. When weaving thermoset tow-preg tapes, steps must be taken to reduce or, preferably, remove the tack from the tapes. This may be done, for example, by adjusting the chemistry of the epoxy or substantially reducing the temperature in the weaving area.

Attaching the various fabric layers 110, 120, 130, 140 may involve, for example, one or more of: gluing, laminating, consolidating, and the like. Various compression or wet lay-up processes may be used to form the skate boot shell 100. Problematically, this layered approach to manufacture does not take into account the need for different structural properties in different portions of the skate boot shell 100.

### SUMMARY OF THE INVENTION

The desired thermoformability characteristics for a conventional skate boot design and the desired flexibility/stiffness characteristics for a conventional skate boot design are shown, respectively, in FIGS. 2A and 2B and FIGS. 2C and 2D. Preferably, as shown in FIGS. 2A and 2B, area 150 is a portion of the skate boot shell 100 in which a high degree of thermoformability is desirable; area 160 is a portion of the skate boot shell 100 in which a medium degree of thermoformability is desirable; and area 170 is a portion of the skate boot shell 100 in which a low or zero degree of thermoformability is desirable. Moreover, as shown in FIGS. 2C and 2D, less stiffness 180 built into the skate boot shell 100 is preferred running in an essentially longitudinal direction along the length of the foot in the midfoot and instep regions of the skate boot shell 100, while more stiffness 190 built into the skate boot shell 100 is preferred running in an essentially horizontal direction in the heel regions of the skate boot shell 100 and in an essentially vertical direction in the toe and midfoot regions of the skate boot shell 100.

Accordingly, it would be desirable to provide a method of manufacturing a skate boot shell in which any number of (e.g., straight, tensioned) fibers having a myriad of varying mechanical properties may be individually oriented in an optimal direction and positioned in precise, discrete locations. The structural layer may be built up into a single, net shape, monolithic, three-dimensional structure that can be molded in a single step. Advantageously, preferred and uncoupled lateral and longitudinal stiffness can be achieved for increased protection due to the ability to concentrate protective materials in vulnerable areas of the wearer's foot. Furthermore, lower weight and better mass distribution can be accomplished by structural efficiencies made possible by the manufacturing process.

In some aspects, embodiments of the invention relate to a method of manufacturing a portion of a boot shell (e.g., a mating component therefor) for an ice skate. In some embodiments, the method includes preparing a monolithic, two-dimensional pattern of the boot shell; positioning the monolithic, two-dimensional pattern into a three-dimensional preform of the boot shell; installing the three-dimensional preform in a mold; and consolidating the three-dimensional preform in the mold to produce the portion of the boot shell (e.g., by applying at least one of heat or pressure). In some implementations, preparing the monolithic, two-dimensional pattern includes at least one of: tailored fiber placement, co-mingled tailored fiber placement, or dry tailored fiber placement. Optionally, the method may also include removing flashing from the consolidated portion of the ice skate.

In some applications, tailored fiber placement may include placing a plurality of fibers (e.g., at discrete locations of the monolithic, two-dimensional pattern, the fibers being oriented in two or more different predetermined orientations. For example, in an ankle portion of the ice skate, the fibers may be oriented horizontally or substantially horizontally to provide lateral support to a wearer's ankle and, in a lower boot portion of the ice skate, the fibers may be oriented vertically or substantially vertically to provide lateral stiffness to a wearer's foot. Furthermore, in an outsole of the ice skate, the fibers may be oriented in a plus or minus 45-degree hatch pattern to provide torsional stiffness as shown in FIG. 6. As an additive manufacturing process, the use of TFP can significantly reduce material cutting loss when compared to traditional subtractive processes like nesting.

In other applications, tailored fiber placement may include placing a plurality of fibers at discrete locations of the monolithic, two-dimensional pattern, the fibers being added to provide a greater thickness in two or more different predetermined orientations. For example, fibers may be added to provide a greater thickness in an ankle portion of the ice skate to provide one or more of greater lateral stiffness or ankle protection. Alternatively, or in addition, fibers may be added to provide a greater thickness in a heel portion of the ice skate to provide one or more of greater stiffness or greater reinforcement to a highly stressed area of the ice skate. Optionally, or in addition, fibers may be added to provide a greater thickness about a forefoot portion and/or a heel portion of a peripheral edge of an outsole of the ice skate to provide additional reinforcement. Optionally, or in addition, tailored fiber placement may include placing a material sheet at a discrete location of the monolithic, two-dimensional pattern, and placing a plurality of fibers at discrete locations of the monolithic, two-dimensional pattern, where the plurality of fibers can couple (e.g., embroider) the material sheet to the monolithic, two-dimensional pattern.

In some variations, the monolithic, two-dimensional pattern may include an asymmetric, non-orthotropic structural material. In other variations, the monolithic, two-dimensional pattern may include one or more layers of traditional woven fabric. In one embodiment, the tailored fiber placement process may be used to install the fibers directly on (e.g., on top of) the fabric. This fabric may include some fibers that are identical to those being applied via tailored fiber placement. In another embodiment, the tailored fiber placement process may be used to install the fibers directly on (e.g., on top of) a substrate, which is then laminated on (e.g., on top of) a woven fabric.

In some variations, the substrate is consolidated with the patterned fibers and becomes integral with the composite shell. In some implementations, the asymmetric, non-orthotropic structural material may include multiple distinct layers joined into the monolithic, two-dimensional pattern. In other variations, the monolithic, two-dimensional pattern may include a plurality of tabs. In some variations, positioning the monolithic, two-dimensional pattern may include securing the overlapping tabs about the three-dimensional preform. Optionally, securing the overlapping tabs may include at least one of stitching, spot welding, or using an adhesive.

In some applications, installing the three-dimensional preform in a mold may include placing an inner mold portion within the three-dimensional preform; and placing the inner mold portion and the three-dimensional preform in an outer mold portion. In some variations, the inner mold portion may be selected from the group consisting of a last, an inflatable bladder, a mandrel a custom printed extrapolation of a wearer's foot, or a custom fabricated extrapolation of the wearer's foot. In some variations, the inner mold portion can include indicators (e.g., visual indicators and/or structural geometry) configured to at least one of receive the three-dimensional preform or guide placement of the three-dimensional preform. In some variations, the inner mold portion may be placed within the three-dimensional preform based on the indicators.

In some variations, the inner mold portion is an inflatable bladder. In some variations consolidating the three-dimensional preform in the mold may include inflating the inflatable bladder by injecting a gas or liquid inside the inflatable bladder, where the inflated bladder is configured to apply pressure onto the three-dimensional preform. In some variations consolidating the three-dimensional preform in the mold may include heating the inner mold portion to increase a size of the inner mold portion relative to a size of the outer mold portion, wherein the heated inner mold portion is configured to apply pressure onto the three-dimensional preform based on the increased size.

In some variations, the three-dimensional preform has a thickness between 0.5 millimeters (mm) and 10 mm. In some variations, the three-dimensional preform is tack-free at ambient temperatures (e.g., 15° C.-25° C.).

In some aspects, embodiments of the invention relate to a method of manufacturing a portion of a boot shell for an ice skate. In some embodiments, the method includes: preparing multiple, two-dimensional patterns of the boot shell; positioning the two-dimensional patterns into a three-dimensional preform of the boot shell; installing the three-dimensional preform in a mold; and consolidating the three-dimensional preform in the mold to produce the portion of the boot shell. In some applications, preparing at least one of the two-dimensional patterns may be accomplished by at least one of: tailored fiber placement, co-mingled tailored fiber placement, or dry tailored fiber placement.

In some aspects, embodiments of the invention relate to a method of manufacturing a portion of a boot shell for an ice skate. In some embodiments, the method includes: preparing a two-dimensional pattern of the boot shell with fiber reinforcement material; positioning the two-dimensional pattern onto (e.g., on top of, under, or adjacent to) a hollow, three-dimensional preform of the boot shell including a thermoformable material, where the thermoformable material is rigid at room temperature (e.g., 15° C.-25° C.) and has a softening point above 40° C. (e.g., above 50° C., or above 100° C.); installing the three-dimensional preform in a mold; and consolidating the three-dimensional preform in the mold to produce the portion of the boot shell.

In some implementations, preparing the two-dimensional pattern of the boot shell with fiber reinforcement material may include one or more of the following: using raw fiber reinforcement material, co-mingled fiber reinforcement material, or combinations thereof; placing a plurality of fibers at discrete locations of the two-dimensional pattern, the fibers being oriented in two or more different predetermined orientations; and/or placing a plurality of fibers at discrete locations of the monolithic, two-dimensional pattern, the fibers being added to provide a greater thickness in two or more different predetermined orientations. In some applications, installing the three-dimensional preform in a mold may include placing the inner mold portion, the three-dimensional preform, and the two-dimensional pattern in an outer mold portion. The two-dimensional pattern may be positioned on (e.g., on top of, under, or adjacent to) the three-dimensional preform.

In some variations, the thermoformable material is a thermoplastic. In some variations, the thermoformable material is an elastomer.

In some aspects, embodiments of the invention relate to an article of footwear for use in ice skating. In some embodiments, the article of footwear includes: a boot shell structured and arranged to accommodate a wearer's foot and having a medial forefoot portion, a lateral forefoot portion, a sole portion, a lateral ankle portion, a medial ankle portion, and a heel portion, where the boot shell further includes (i) a first thermoformable material having a softening point between 40° C. and 100° C., and (ii) a plurality of fibers, where the fibers are (i) at least one of adjacent to or integrated within the first thermoformable material.

In some variations, the first thermoformable material is located in at least one of the lateral ankle portion or the medial ankle portion of the boot shell, the medial forefoot portion of the boot shell, and/or the lateral forefoot portion of the boot shell. In some variations, the first thermoformable material is interleafed between a first exterior layer of the boot shell and a second exterior layer of the boot shell, where both the first and second exterior layers include a material different from the first thermoformable material.

In some variations, the plurality of fibers are configured to increase a flexural modulus of the first thermoformable material. In some variations, the plurality of fibers can be structural fibers (e.g., carbon fiber, fiberglass, aramid, etc.). In some variations, the plurality of fibers can include at least one of a plurality of raw fibers or a plurality of co-mingled fibers.

In some applications, the plurality of fibers are positioned at discrete locations of the boot shell, the plurality of fibers being oriented in two or more different predetermined orientations. In some variations, the plurality of fibers are positioned at discrete locations of the boot shell, the plurality of fibers providing a greater thickness in two or more different predetermined orientations.

In some variations, a current carrying material is embedded within the boot shell adjacent to the first thermoformable material. In an example, the current carrying material is configured to generate heat to cause a temperature of the first thermoformable material to be greater than or equal to the softening point of the first thermoformable material. In some variations, a current carrying material is interleafed between a first exterior layer of the boot shell and a second exterior layer of the boot shell.

In some variations, the boot shell may include a second thermoformable material having a softening point above 100° C. (e.g., above 120° C., 150° C., or 200° C.), where the second thermoformable material includes the plurality of fibers. In some variations, the second thermoformable material is located in at least one of the lateral ankle portion or the medial ankle portion of the boot shell, the medial forefoot portion of the boot shell, and/or the lateral forefoot portion of the boot shell.

In some variations, a current carrying material is embedded within the boot shell adjacent to the second thermoformable material. In an example, the current carrying material is configured to generate heat to cause a temperature of the second thermoformable material to be greater than or equal to the softening point of the second thermoformable material. In some variations

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of embodiments of the invention. In the following description, various embodiments of the present invention are described with reference to the following drawings, in which:

FIG. 1A shows a lateral side elevation view of a conventional hockey skate with a composite boot shell, in accordance with the prior art;

FIG. 1B shows an illustrative embodiment of an assembly of a plurality of composite/material fibers that are oriented symmetrically relative to one another, in accordance with the prior art;

FIGS. 2A and 2B show illustrative embodiments of regions of desired thermoformability in a skate boot shell;

FIGS. 2C and 2D show illustrative embodiments of regions of desired flexibility/stiffness in a skate boot shell;

FIG. 3 shows an illustrative preform with horizontal reinforcement in ankle and heel regions of a skate boot shell, in accordance with some embodiments of the invention;

FIG. 4 shows an illustrative preform with vertical reinforcement in a lower boot area of a skate boot shell, in accordance with some embodiments of the invention;

FIG. 5 shows an illustrative preform with extra fiber thickness in ankle and heel regions of a skate boot shell, in accordance with some embodiments of the invention;

FIG. 6 shows an illustrative preform with torsional stiffness reinforcement for an outsole, in accordance with some embodiments of the invention;

FIG. 7 shows an illustrative preform with extra thickness added to the outsole in toe and heel portions of the lateral and medial sides of an outsole, in accordance with some embodiments of the invention;

FIG. 8 shows an illustrative composite preform of a skate boot shell and outsole, in accordance with some embodiments of the invention;

FIGS. 9A-9F show an illustrative method of manufacturing a skate boot shell, in accordance with some embodiments of the invention;

FIGS. 10A-10B show an illustrative mold for manufacturing a skate boot shell, in accordance with some embodiments of the invention;

FIG. 11A shows illustrative embodiments of regions of desired thermoformability in a skate boot shell and a cross-sectional position in the skate boot shell, in accordance with some embodiments of the invention;

FIG. 11B shows a cross-sectional view of the cross-sectional position of the skate boot shell of FIG. 11A, in accordance with some embodiments of the invention;

FIG. 12A shows a composite skate boot shell in which the different types of the fibers are provided in different portions of the preform, in accordance with some embodiments of the invention;

FIG. 12B shows a composite skate boot shell in which the orientation of the fibers are oriented asymmetrically, in accordance with some embodiments of the invention;

FIG. 12C shows a composite skate boot shell in which the number and thickness of the fibers are varied in different portions of the preform, in accordance with some embodiments of the invention;

FIG. 13 shows an exemplary relationship between angle of fiber orientation and stiffness, in accordance with some embodiment;

FIG. 14A shows a skate boot shell including a flex rail feature in an at-rest state; in accordance with some embodiments of the invention;

FIG. 14B shows the skate boot shell of FIG. 14A in a compressed state, in accordance with some embodiments of the invention;

FIG. 15 shows a composite skate boot shell in which a conductive wire or filament is embroidered into the preform, in accordance with some embodiments of the invention;

FIG. 16 shows a conductive wire or filament embroidered into the preform, in accordance with some embodiments of the invention; and

FIG. 17 shows a composite skate boot shell in which the orientation of the fibers define, create, or reinforce eyelets in the skate boot shell, in accordance with some embodiments of the invention.

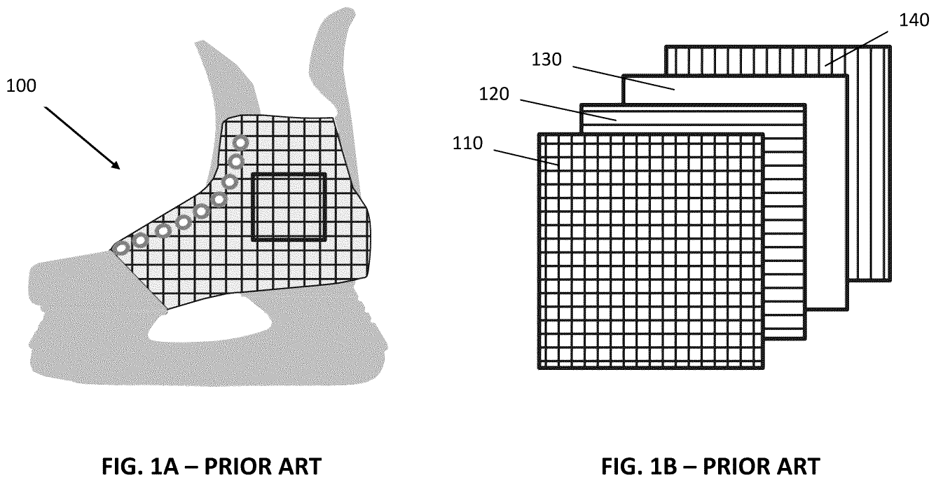

### DETAILED DESCRIPTION

Tailored fiber placement (TFP) is an embroidery-based, tow-steering process that enables complete control over fiber placement and directionality. Succinctly, TFP enables embroidering and tacking a single, continuous fiber (or “tow”) or, alternatively, tacking any number of fibers of the same or different composition, onto a substrate in a process known as roving. For the purpose of illustration rather than limitation, the term “fibers” used in this description includes non-orthotropic structural material that may be raw fibers as well as co-mingled fibers. Raw fibers may be defined as a single tow comprised of one or more materials, which can include glass fibers, carbon fiber, fiberglass, glass fiber, copper filament, metal filament (e.g., steel filament and the like), aromatic polyamid (aramid), polydioxanone (PDO), polyester, polypropylene (PP), and the like. Typically, when raw fibers are used, a resin (e.g., epoxy) matrix is introduced (e.g., via vacuum-assisted resin transfer molding (VARTM), infusion, wet lay-up, film lamination, and so forth) to create a composite structure. Co-mingled fibers are composed or two or more fibers made from different materials, one of which is often a thermoplastic fiber (e.g., nylon, polyester, aramid, polyamide 6 (PA6), polyamide 12 (PA12), PEAK, poly(p-phenylene-2,6-benzobisoxazole) (PBO), polymethyl methacrylate (PMMA), PP, and the like) or thermoset fiber (e.g., epoxy) that, upon heating, produces a resin matrix. Representative examples of co-mingled fibers (e.g., co-mingled thermoplastic fibers) include: carbon fiber/PA6, carbon fiber/PEAK, fiberglass/PA6, aramid/PA12, and so forth. Typically, co-mingled fibers may be heated to melt the thermoplastic material until flowing, which becomes a resin matrix that envelopes the remaining (e.g., solid) material(s) of the co-mingled fibers. An advantage to the use of co-mingled fibers is integration of the resin matrix directly into the fibers. By integrating the resin matrix directly into the co-mingled fibers, it is no longer necessary to introduce the resin matrix in a secondary step (e.g., VARTM, infusion, wet lay-up, film lamination, and so forth). A second advantage to the use of co-mingled fibers is the even distribution of the resin matrix relative to the fibers in a preform including the fibers. For example, when the co-mingled fibers are heated to melt the thermoplastic material until flowing, the thermoplastic material can evenly distribute across the remaining material(s) of the co-mingled fibers. Such use of co-mingled fibers reduces the likelihood of generating a finished shape or product with an uneven fiber volume fraction across the structure.

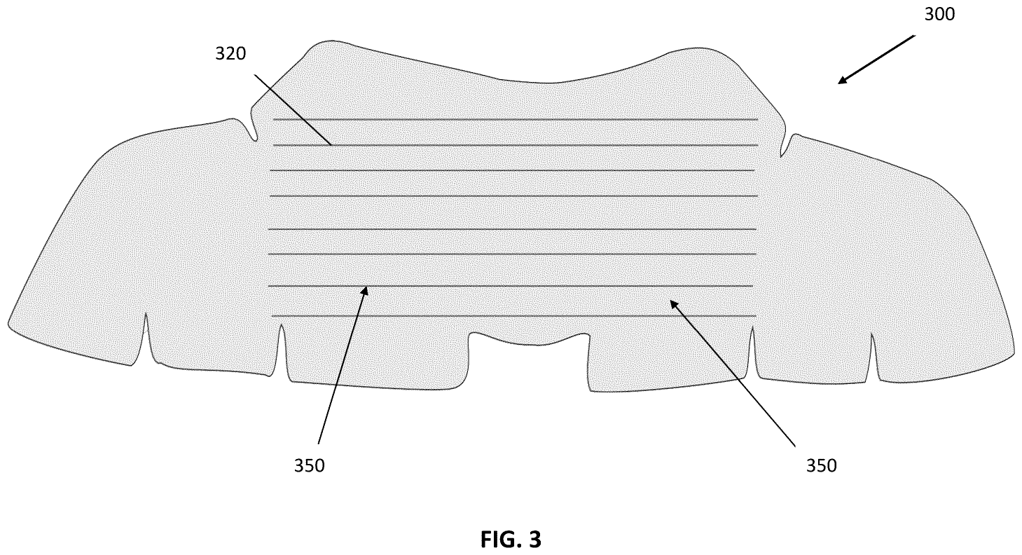

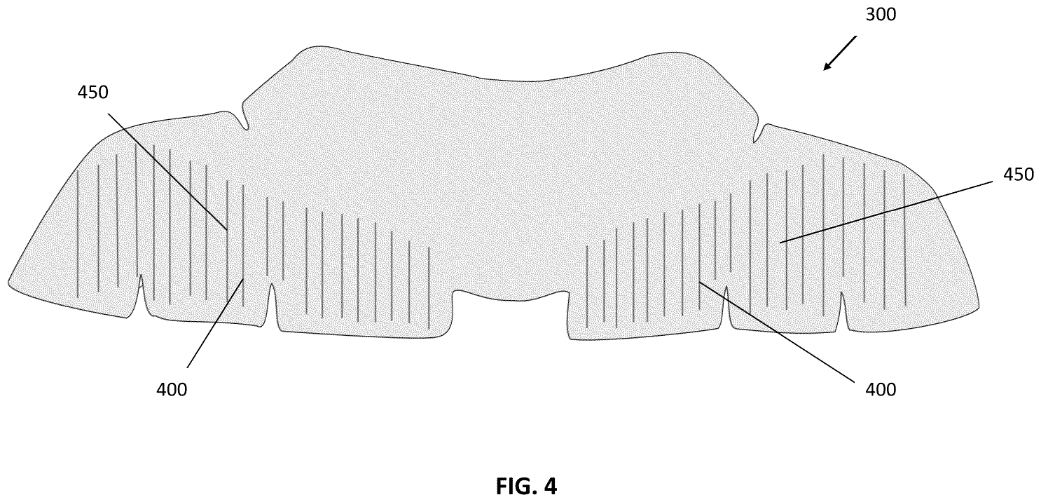

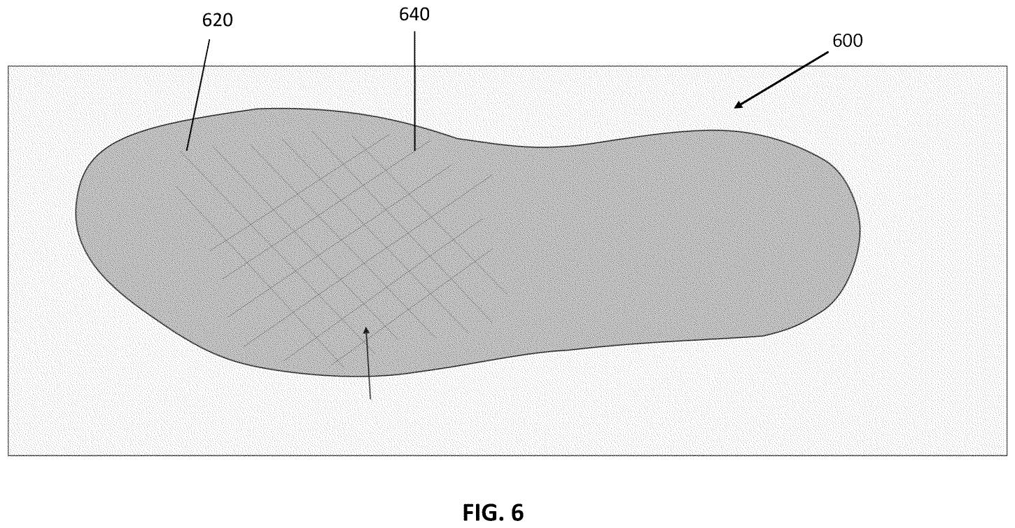

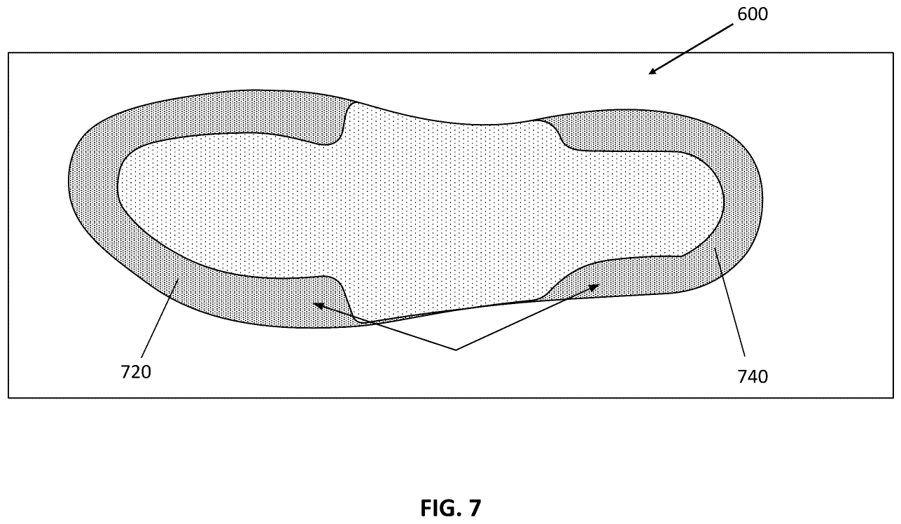

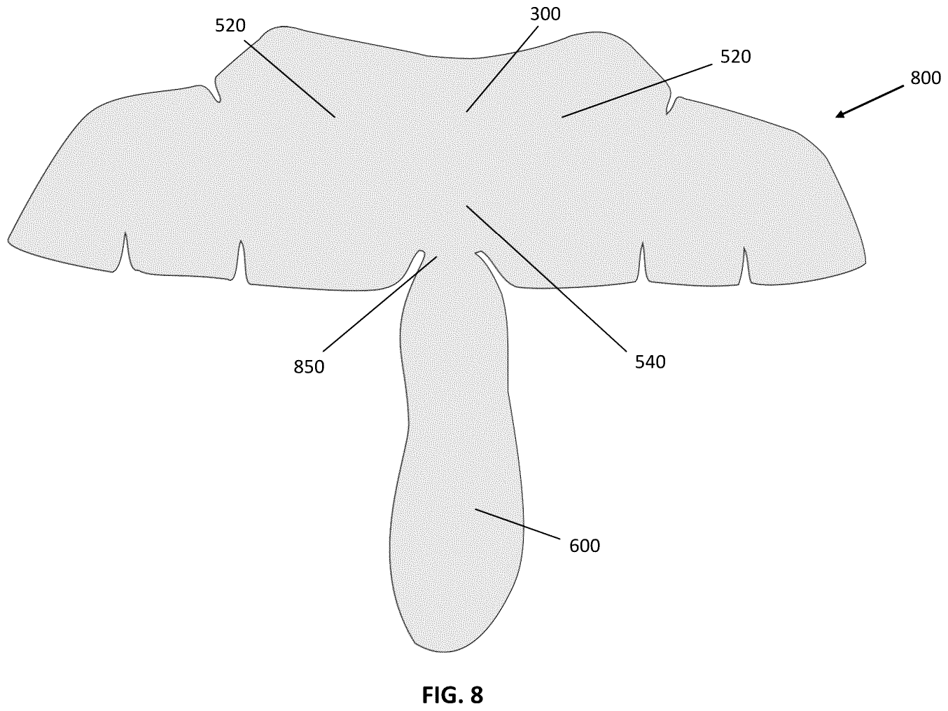

In some embodiments of the present disclosure, TFP may be used, such that a pattern or preform of a part resembling a desired, finished shape or product (e.g., a skate boot shell, a mating component therefor, and the like) may be embroidered onto a substrate. The desired, finished shape or product described herein may be a skate boot shell (e.g., formed from the preform 300 of FIGS. 3-5), an outsole for a skate boot (e.g., formed from the outsole preform 600 of FIGS. 6 and 7), and/or a composite skate boot shell and outsole (e.g., formed from the preform 800 of FIG. 8). In some variations, the desired, finished shape or product may be a mating component for a skate boot shell such as a tendon guard, a toe cap, an ankle cuff, and so forth.

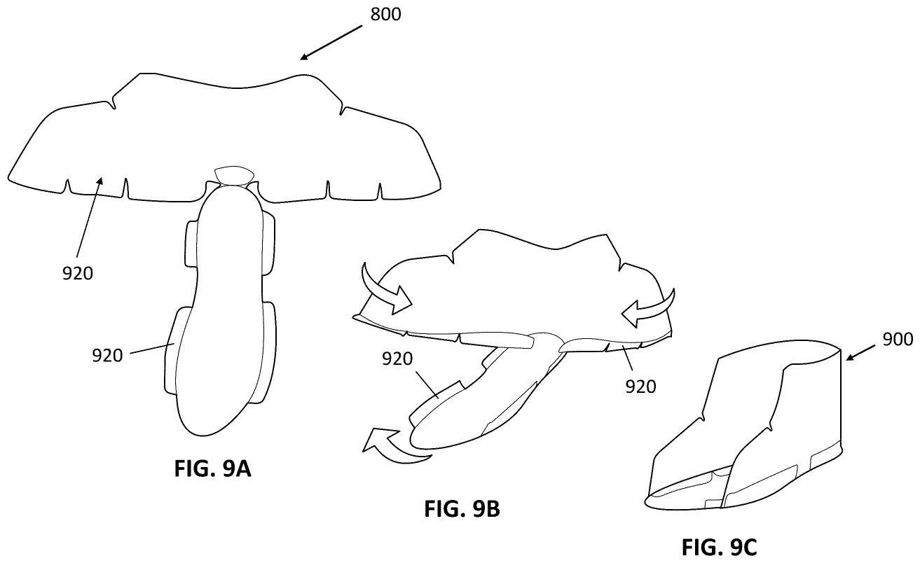

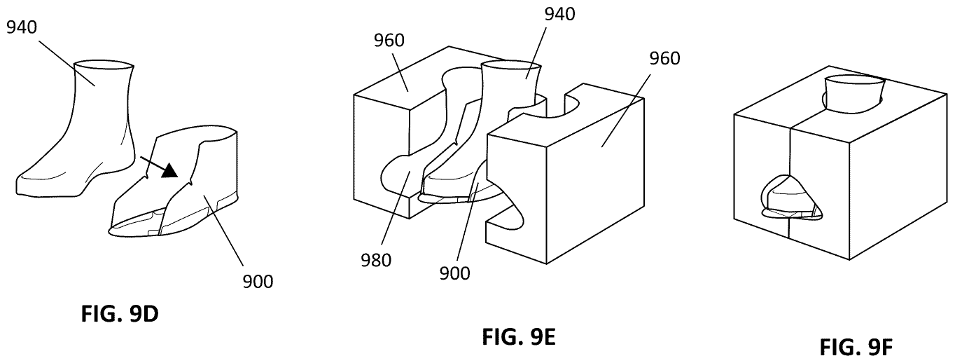

Accordingly, as shown in FIG. 9A, in a first step of the manufacturing process, a monolithic, (e.g., substantially) two-dimensional pattern or preform 800 of a part resembling a desired, finished shape or product may be embroidered onto a substrate. The pattern or preform may be embroidered by using, for example, stitching with a yarn. The monolithic, (e.g., substantially) two-dimensional pattern or preform 800 may be made of one or more layers of the same or different raw or co-mingled fibers that are fixed to the substrate (e.g., using a stitching yarn) to provide a desired thickness. Successive (e.g., structural) layers may be attached via the same stitching yarn, so that multiple, distinct opposing layers providing variable thicknesses at precise and discrete locations on the preform 800 are rigidly fixed together (i.e., via the stitching). The stitching yarn may be comprised of a thermoplastic polymer (e.g., PA6) that melts during the molding process. In another embodiment, the stitching yarn may be a structural fiber (e.g., aramid) that holds the successive layers together and, preferably, reduces the risk of delamination in the final structure. These stitching yarns may interact with all or only certain embroidered layers, to influence material properties in the z-direction.

In some implementations, the monolithic, (e.g., substantially) two-dimensional pattern or preform 800 may include one or more pre-shaped (e.g., die-cut, CNC processed) sheets that are incorporated into the preform 800 as an intermediary layer or a final layer. A pre-shaped sheet may be incorporated into the preform 800 by pausing the embroidery process (e.g., embroidery of the fiber), placing a pre-shaped sheet onto a particular location of the preform 800, and then continuing the embroidery process such that the sheet becomes integral to the preform. The pre-shaped sheets may include one of or a combination of thermoplastics, elastomers (e.g., fiber re-enforced, uncured, semi-cured, or cured elastomers), structural fibers differing from those for embroidery (e.g., glass, hemp, or carbon fibers), adhesives, and/or materials to facilitate demolding (e.g., Teflon). In some implementations, the thermoplastics used in the pre-shaped sheets may include thermoplastics that are thermoformable at lower temperatures (e.g., at or below 100° C.) than the rest of the preform 800. Some examples of thermoplastics used in the pre-shaped sheets can include an ionomer resin (e.g., SURLYN polymer from DuPont, a co-polymer of ethylene and methacrylic acid, and the like) and polyester (e.g., polycaprolactone (PCL)). An example of a composite material including and/or made of thermoplastics and structural fibers can include REFORM RX3185 from Texon. An example of an elastomer (e.g., thermoformable elastomer) used in the pre-shaped sheets can include KRAIBON elastomer available from Kraiburg.

In some implementations, the substrate material can be made from a variety of materials from (e.g., thin) non-woven scrims to structural fabrics. Advantageously, in some variations, the substrate material may be made from a dissolvable material that may be removed (i.e., by dissolution) during subsequent manufacturing steps prior to the consolidation step. In other variations, the substrate may be made from a thermoplastic film, non-woven scrim, veil, or fabric that melts during the molding process and serve as a matrix in the composite structure. In one embodiment, the substrate material may be a film produced from the same polymer as used in the co-mingled fiber such that both the filaments in the co-mingled fiber and the film melt at the same or substantially the same temperature and create a uniform matrix.

Once the monolithic, (e.g., substantially) two-dimensional pattern or preform 800 has been prepared, as shown in FIG. 9B, the two-dimensional pattern or preform 800 may be positioned (e.g., formed or folded) into a three-dimensional preform 900 and secured to itself (FIG. 9C). In some implementations, multiple preforms 800 may be joined and positioned (e.g., formed or folded) to form one three-dimensional preform 900. When multiple preforms 800 are be joined and positioned to form one three-dimensional preform 900, a particular preform 800 may be secured to itself and/or to another preform 800 of the multiple preforms 800. During positioning of the preform(s) 800 into a three-dimensional preform 900, additional materials may be added to the preform(s) 800 (e.g., between layers of different preforms 800 or on a surface of a preform 800). Adding one or more additional materials on the preform 800 can include using an adhesive, spot (heat) welding, stitching, and the like. The preform 900 may be sufficiently drape-able to be formed at ambient temperatures or may be heated to increase drape-ability. Securing the three-dimensional preform 900 may include using an adhesive, spot (heat) welding, stitching, and the like. Some examples of adhesives used for adding additional materials to the preform 800 and/or securing the three-dimensional preform 900 may include spray adhesives, film adhesives, and liquid adhesives. In some cases, the preform 900 may have a thickness ranging from about 0.55 millimeters (mm) to about 10 mm. In some cases, the preform 900 may be tack-free at ambient temperatures (e.g., between 15° C. to 25° C.).

Advantageously, in some variations, the two-dimensional pattern or preform 800 may include a plurality of tabs 920 that may be used (e.g., overlapped) to secure one or multiple two-dimensional pattern or preforms 800 as the three-dimensional preform 900. At least some of the tabs 920 may extend from a periphery of the preform 800. In some implementations, multiple preforms 800 may be stacked together and/or interleafed and held in place exclusively by the pressure generated by closing the mold. In some implementations one or more two-dimensional preforms 800 may be placed onto (e.g., on top of or adjacent to) a preform 900 before the preform (e.g., including a preform 800 and preform 900) is molded into a consolidated skate boot shell.

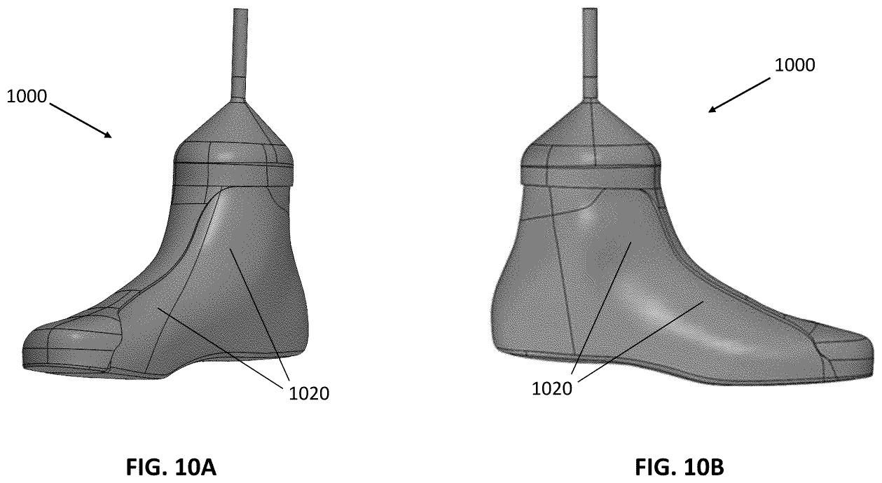

Once the three-dimensional preform 900 has been secured onto itself, as shown in FIG. 9D, a (e.g., male) mold 940 may be installed within (e.g., inserted into) the three-dimensional preform 900. Exemplary embodiments of the (e.g., male) mold 940 may include, for the purpose of illustration rather than limitation: a last, a (e.g., inflatable) bladder, a mandrel, a printed extrapolation (i.e., scan data) of a wearer's foot, a fabricated extrapolation of the wearer's foot, and so forth. In the case of a bladder, the bladder may be made of and/or include materials that can withstand high temperatures, such as silicone, TEFLON, and the like to withstand the temperatures required to melt traditional thermoplastics. For example, silicone can remain stable up to 160° C. In some implementations, a mandrel that is rigid at room temperature (e.g., to allow proper lamination), such as a polymer (e.g., PP) mandrel, while softening at the molding temperatures may also serve as a bladder imparting pressure on the preform 900. In some implementations, when the (e.g., male) mold 940 is a mandrel (e.g., rigid mandrel), the mandrel may include visual indications (e.g., markers, indicators, boundary lines, and the like) and/or or structural geometry (e.g., raised or indented structures) which are configured to receive the preform 900 and/or guide placement of the preform 900 on the mandrel to improve efficiency and consistency (e.g., with respect to a manufacturing process). As an example, as shown in FIGS. 10A and 10B, an example of a (e.g., male) mold can be a rigid mandrel 1000 that includes an indented structure 1020 on which the preform 900 is placed, where the boundaries of the indented structure 1020 are structured to accommodate a shape of the preform 900. The indented structure 1020 can be preferred for enabling the preform 900 to be placed precisely on a (e.g., male) mold and within an inner space of a (e.g., female) mold. Further, the indented structure 1020 can limit movement of the preform 900 during a process for forming the consolidated skate boot shell. Additionally, the addition of visual markings allow laborers to locate and place preform on the mandrel 1000 more quickly and efficiently. In some variations, other embodiments of a (e.g., male) mold may include the visual and/or or structural geometry described herein. In some implementations, a mandrel functioning as a (e.g., male) mold may impart pressure on the preform 900, where the mandrel has a thermal expansion rate high enough to exert pressure on the preform 900 when heated to the molding temperatures (e.g., causing expansion of the preform 900 in size and/or volume). Some examples of materials suitable for a mandrel having a high coefficient of thermal expansion (CTE) may include aluminum and silicone.

As shown in FIG. 9E, the (e.g., male) mold 940 and three-dimensional preform 900 may then be installed in a (e.g., female alloy) mold 960 having an inner space 980 that is structured and arranged to provide the final, desired shape or pattern. In some cases, the mold 940 may be an inner mold and the mold 960 may be an outer mold configured to receive the mold 940. A combination of the mold 940 and the mold 960 can form a curing system for forming the preform 900 into the consolidated skate boot shell. Once the (e.g., male) mold 940 and three-dimensional preform 900 have been properly installed in the (e.g., outer, female alloy) mold 960 (FIG. 9F), the preform 900 may then be consolidated using one or more of a variety of forming processes, such as heat, pressure, compression, wet lay-up, vacuum forming, and so forth. The finished, consolidated skate boot shell may be removed from the mold 960 and the (e.g., male) mold 940 portion may be removed from the inside of the consolidated skate boot shell. Finally, flashing (e.g., excess material) from the consolidated skate boot shell may be trimmed and the skate boot shell may be added to the rest of the ice skate. In some implementations, a mold 940 may be a mandrel made of and/or including a higher CTE material (e.g., aluminum, silicone) and a mold 960 may be made of and/or include a lower CTE material (e.g., steel). When the preform 900, mold 940, and mold 960 are heated to the molding temperature, the mold 940 (e.g., higher CTE mandrel) may expand relative to the mold 960 (e.g., lower CTE mold relative to the higher CTE mandrel). Thus, the cavity between the molds 940 and 960 (e.g., within the inner space 980) is reduced and pressure is applied to the preform by the mold 940.

Optionally, in some embodiments, when using raw fibers (i.e., free of matrix material), a dry TFP preform may be produced, for example, by assembling structural fibers (e.g., carbon fiber) to the substrate using a stitching thread. In this case, a resin matrix must be introduced in a second step in order to wet out the fibers. In one embodiment, the dry TFP preform may be placed inside a curing system (e.g., combination of the molds 940 and 960) prior to adding an uncured matrix material (e.g., an epoxy) via VARTM. In another embodiment, an uncured matrix material may be added directly to the dry TFP preform immediately before placing it inside the curing tool. In a final embodiment, an uncured matrix material may be added directly to the dry TFP preform before laminating the part to a tool and applying a non-porous vacuum bag over top to impart pressure via a vacuum (i.e., negative pressure).

Advantageously, the process involves replacing the labor-intensive steps of cutting, assembling, and consolidating multiple fabric layers with a TFP-based process that embroiders a single preform onto a substrate without requiring cutting or trimming the finished product. Moreover, the TFP process enables precise fiber placement about the preform, which reduces waste and provides performance characteristics such as targeted asymmetrical flexure.

In some implementations, one or more of the TFP techniques described herein may be used to manufacture a skate boot shell, a mating component therefor, and the like. For example, at least some of the TFP techniques described herein may be used to manufacture a lower softening point (e.g., thermoformable) material, a more rigid (e.g., higher softening point) material, and/or an insert to be included in a skate boot shell, a mating component therefor, and the like.

### Thermoformable Materials

Structural materials with a lower softening point are typically substantially softer than equivalent materials with higher softening points. The lower stiffness can reduce the protection and support of a boot structure incorporating the lower softening point materials. Therefore, the designer may consider a boot structure comprised of both low softening point material(s) and more rigid (e.g., high softening point) material(s).

In one embodiment, a lower softening point (e.g., thermoformable) material may be interleafed between multiple (e.g., two) layers of a more rigid (e.g., higher softening point) material. In this example, the shape of the boot shell may be adjusted by heating the boot shell above the softening point of the interleafed (e.g., lower softening point) material and immediately applying pressure to the boot shell. When the interleafed material is heated above its softening point, application of pressure to the boot shell may cause the more rigid (e.g., higher softening point) materials to translate relative to each other as the interleafed material retains the new shape based on the applied pressure.

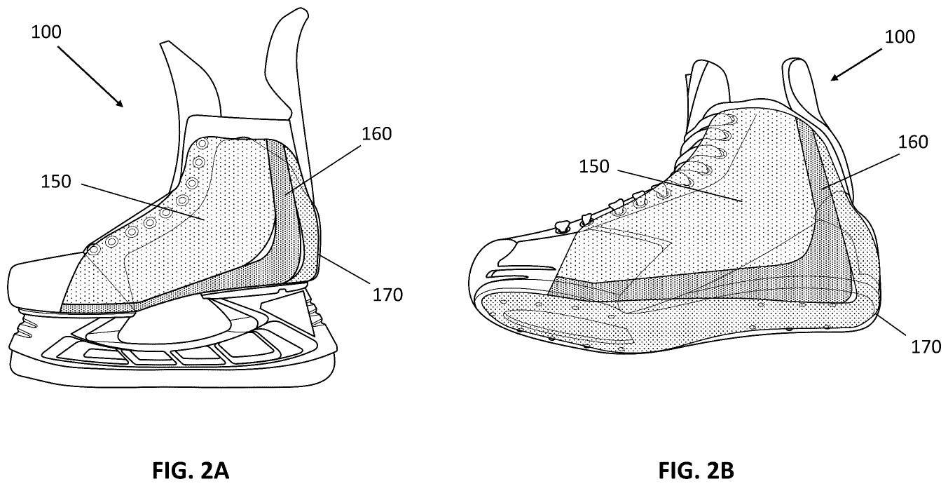

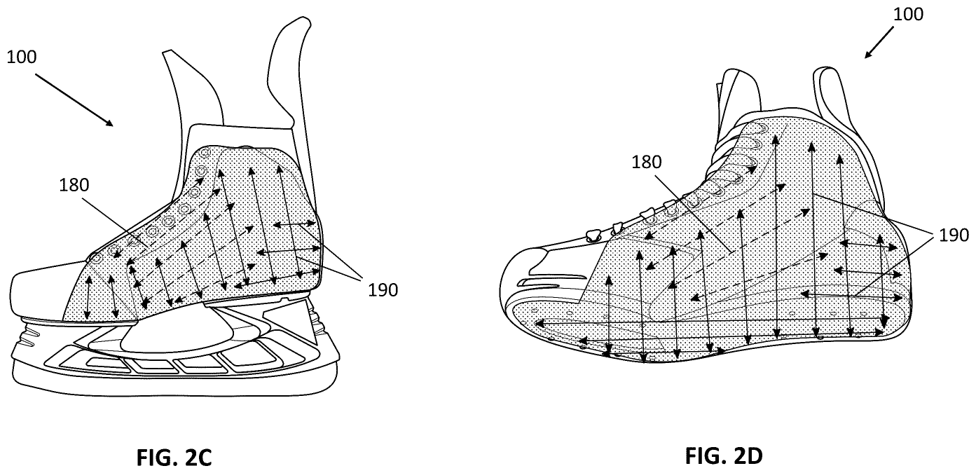

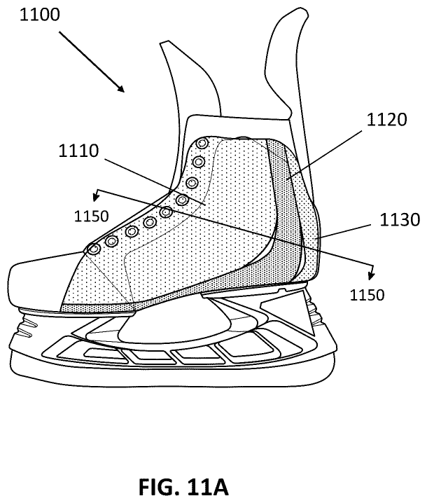

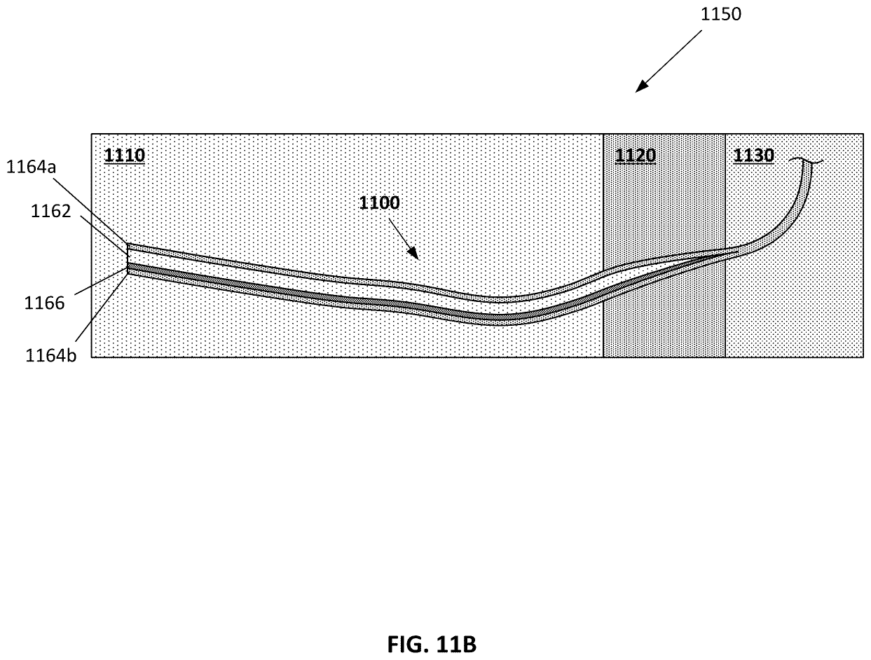

A boot shell having the desirable thermoformability as illustrated in FIGS. 2A-2B may be provided as follows. As shown in FIG. 11A, a skate boot shell 1100 can include a low thermoformability area 1110, a medium thermoformability area 1120, and a high thermoformability area 1130. The low thermoformability area 1110 is a portion of the skate boot shell 1100 in which a high degree of thermoformability is provided; the medium thermoformability area 1120 is a portion of the skate boot shell 1100 in which a medium degree of thermoformability is provided; and the high thermoformability area 1130 is a portion of the skate boot shell 1100 in which a low or zero degree of thermoformability is provided. Referring also to FIG. 11B, a cross-sectional view 1150 of the skate boot shell 1100 depicts a construction of a number of layers of the skate boot shell 1100 relative to the low thermoformability area 1110, medium thermoformability area 1120, and high thermoformability area 1130. The boot shell 1100 can include a lower softening point material layer 1162. The boot shell 1100 can include multiple higher softening point material layers, such as a first more rigid (e.g., higher softening point) material layer 1164a and a second more rigid (e.g., higher softening point) material layer 1164b (collectively referred to as “more rigid material layers 1164”). The lower softening point material layer 1162 may be interleafed between the more rigid material layers 1164, with the more rigid material layers 1164 forming the exterior of the boot shell 1100. In this example, the shape of the boot shell 1100 may be adjusted by heating the boot shell 1100 above the softening point of the lower softening point material (e.g., interleafed) layer 1162 and immediately applying pressure to the boot shell 1100. When the lower softening point material (e.g., interleafed) layer 1162 is heated above its softening point, application of pressure to the boot shell 1100 may cause the more rigid material layers 1164 to translate relative to each other as the interleafed layer 1162 retains the new shape based on the applied pressure. In some variations, the lower softening point material used in the lower softening point material layer 1162 may have a softening point between 40° C. and 100° C. Some examples of thermoplastic materials for the lower softening point material layer 1162 can include an ionomer resin (e.g., SURLYN polymer from DuPont, a copolymer of ethylene and methacrylic acid, and the like) and polyester (e.g., polycaprolactone (PCL)). An example of a composite material including and/or made of thermoplastics and structural fibers for the interleafed layer 1162 can include REFORM RX3185 from Texon. In some variations, the more rigid (e.g., higher softening point material) used in a more rigid layer 1164 may have a softening point above 100° C. Some examples of materials suitable for the more rigid layers 1164 can include glass fibers, carbon fibers, fiberglass, natural fibers (e.g., hemp, flax, and the like), thermoplastic fibers (e.g., nylon, polyester, aramid, PA6, PA12, PEAK, PBO, PMMA, PP, and the like), composite plastics, metallic fibers (e.g., steel wire, copper wire, and the like), co-mingled thermoplastic fibers (e.g., aramid/PA12, fiberglass/PA6, carbon fiber/PEAK, carbon fiber/PA6, and so forth), thermoset tow-preg tapes (e.g., carbon/epoxy, fiberglass/epoxy, and so forth), thermoplastic tapes and combinations thereof.

In some embodiments, the lower softening point material layer 1162 can be included in the skate boot shell at one or more areas or portions of the skate boot shell. The lower softening point material layer 1162 may be located at a medial forefoot portion, a lateral forefoot portion, a sole portion, a lateral ankle portion, a medial ankle portion, and/or a heel portion of the skate boot shell. In some embodiments, the more rigid material layers 1164 can be included in the skate boot shell at one or more areas or portions of the skate boot shell. The more rigid (e.g., higher softening point) material may be located at a medial forefoot portion, a lateral forefoot portion, a sole portion, a lateral ankle portion, a medial ankle portion, and/or a heel portion of the skate boot shell. In some variations, the lower softening point material and the more rigid (e.g., higher softening point) material can be located at the same and/or different positions or areas of the skate boot shell. In some variations, the more rigid layers 1164 including the higher softening point material can be asymmetric, such that area(s) or portion(s) of the skate boot shell include one or multiple more rigid layers 1164 at a particular position or area on the skate boot shell.

In addition, or alternatively, the boot shell may include an insert or inserts interleafed in strategic areas between the outside (e.g., more rigid and/or higher softening point) structural layer(s) and inside (e.g., lower softening point) structural layer(s) to increase performance, structural integrity, protection, and/or fit. The material of the insert or inserts may be comprised of a lower density material such that the moment of inertia in this strategic area is higher and, thus, the local stiffness is increased. In another embodiment, the insert may be comprised of a material with a lower elastic and/or shear modulus for enhanced local flexibility. In another embodiment, the insert may be comprised of an energy absorbing material intended to increase protection in that area. In another embodiment, the insert may be comprised of a thermoplastic material or fiber-reinforced thermoplastic material that allows the region of the boot to be customized using heat and pressure. In some embodiments, the insert or inserts can be included in the skate boot shell at more areas or portions of the skate boot shell. The insert or inserts may be located at a medial forefoot portion, a lateral forefoot portion, a sole portion, a lateral ankle portion, a medial ankle portion, and/or a heel portion of the skate boot shell.

As shown in FIG. 11B, the skate boot shell 1100 can include an insert layer 1166 that is interleafed between the lower softening point material layer 1162 and the more rigid layers 1164. Such an insert layer 1166 may increase performance, protection, and/or fit of the skate boot shell 1100. In some implementations, the insert layer 1166 may be comprised of a lower density material, an energy absorbing material, a thermoplastic material, or a fiber-reinforced thermoplastic material. In an example, the insert layer 1166 may be an elastomeric material (e.g., KRAIBON elastomer from Kraiburg). To promote or reduce a degree of thermoformability in the skate boot shell 1100, each of the layer lower softening point material 1162 and the insert layer 1166 may be placed in strategic locations of the skate boot shell 1100. Further, as shown in FIG. 11B, a cross-sectional thickness of one or more of the lower softening point material layers 1162, more rigid layers 1164, and insert layer 1166 of the skate boot shell 1100 may vary in strategic locations of the skate boot shell 1100 (e.g., to define the low thermoformability area 1110, medium thermoformability area 1120, and high thermoformability area 1130).

It is common for ice hockey boots to be heated using an oven. In this case, the entire boot is heated up. In this scenario, one is limited to temperatures that can be tolerated by the wearer's skin. Therefore, it is preferred to employ materials with a softening point below 100° C. that remain rigid at room temperature (e.g., 15° C. to 25° C.). Traditional boot-making materials such as PA66, PA6, and PA12 have softening points well above 100° C. and are, therefore, less optimal for thermoforming. Some examples of thermoplastic materials with a softening point below 100° C. are an ionomer resin (e.g., SURLYN polymer from DuPont, a copolymer of ethylene and methacrylic acid, and the like), modified PP such as isotactic PP, modified PA, modified PE, polyester (e.g., PCL), co-polymer resin systems, and some bio-based thermoplastics.

In some implementations, the boot shell may be comprised of thermoformable (e.g., thermoplastic) materials with a softening point below 100° C. reinforced with structural fibers (e.g., carbon fiber, fiberglass, aramid, etc.), such that the shape of the rigid structures of the boot may be modified and/or re-shaped by exposing the boot to temperatures below 100° C. and placing the boot directly on the foot of the consumer. When the thermoformable material is heated above its softening point, application of pressure to the boot shell may cause the fibers to translate relative to each other as the lower softening point material retains the new shape based on the applied pressure.

In some implementations, the fibers can be positioned adjacent to the thermoformable material and/or integrated within the thermoformable material. In this example, in some variations, the thermoformable material reinforced by the fibers may have a softening point between 40° C. and 100° C. Some examples of thermoplastic materials for the thermoformable material can include an ionomer resin (e.g., SURLYN polymer from DuPont, a copolymer of ethylene and methacrylic acid, and the like) and polyester (e.g., polycaprolactone (PCL)). In some variations, the fibers may have a softening point above 100° C. Some examples of materials suitable for the fibers can include glass fibers, carbon fibers, fiberglass, natural fibers (e.g., hemp, flax, and the like), thermoplastic fibers (e.g., nylon, polyester, aramid, PA6, PA12, PEAK, PBO, PMMA, PP, and the like), composite plastics, metallic fibers (e.g., steel wire, copper wire, and the like), co-mingled thermoplastic fibers (e.g., aramid/PA12, fiberglass/PA6, carbon fiber/PEAK, carbon fiber/PA6, and so forth), and combinations thereof.

In some embodiments, using non-TFP manufacturing techniques, tapes and/or fabrics may be used (e.g., with thermoformable materials) to form a pattern or preform of a part resembling a desired, finished shape or product (e.g., a skate boot shell, a mating component therefor, and the like) by adding the tapes and/or fabric onto a substrate as described herein. Such a preform may be combined with a thermoformable material and consolidated to form a desired, finished shape or product. In some cases, the tapes and/or fabrics may be added directly onto the thermoformable material as reinforcements, and then consolidated to form a desired, finished shape or product. The desired, finished shape or product described herein may be a skate boot shell (e.g., formed from the preform 300 of FIGS. 3-5), an outsole for a skate boot (e.g., formed from the outsole preform 600 of FIGS. 6 and 7), and/or a composite skate boot shell and outsole (e.g., formed from the preform 800 of FIG. 8). In some variations, the desired, finished shape or product may be a mating component for a skate boot shell such as a tendon guard, a toe cap, an ankle cuff, and so forth.

In some embodiments, fabric comprised of co-mingled fibers that include structural fibers (e.g., carbon fiber) and thermoplastic fibers (e.g., nylon, polyester, aramid, PA6, PA12, PEAK, PBO, PMMA, PP, and the like)) may be used with a thermoformable material in the construction of a skate boot shell, a mating component therefor, and the like. In this example, the fabric may be laminated on (e.g., on top of, under, or on both sides of) the thermoformable material to produce a preform. In some variations, heat may be applied to the preform to mate opposing layers of the preform together. In some variations, adhesives may be used to mate opposing layers of the preform together. In some cases, multiple fabrics may be laminated onto both sides of the thermoformable material, such that the thermoformable material is interleafed between the fabrics.

In some embodiments, fabric comprised of co-mingled fibers that include structural fibers (e.g., carbon fiber) and thermoplastic powder (e.g., nylon) may be used with a thermoformable material in the construction of a skate boot shell. In this example, the fabric may be laminated on (e.g., on top of, under, adjacent to, or on both sides of) the thermoformable material to produce a preform. In some variations, heat may be applied to the preform to mate opposing layers of the preform together. In some variations, adhesives may be used to mate opposing layers of the preform together. In some cases, multiple fabrics may be laminated onto both sides of the thermoformable material, such that the thermoformable material is interleafed between the fabrics.

In some embodiments, fabric comprised of woven tapes (e.g., fiber-reinforced, thermoplastic tapes) that include structural fibers (e.g., carbon fiber) and thermoplastic (e.g., nylon) may be used with a thermoformable material in the construction of a skate boot shell. In this example, the fabric may be laminated on (e.g., on top of, under, adjacent to, or on both sides of) the thermoformable material to produce a preform. In some variations, heat may be applied to the preform to mate opposing layers of the preform together. In some variations, adhesives may be used to mate opposing layers of the preform together. In some cases, multiple fabrics may be laminated onto both sides of the thermoformable material, such that the thermoformable material is interleafed between the fabrics.

In some embodiments, a number of tapes (e.g., fiber-reinforced, thermoplastic tapes) that include structural fibers (e.g., carbon fiber) and thermoplastic (e.g., nylon) may be used in the construction of a skate boot shell. The tapes may be applied to a surface in different orientations and welded together (e.g., using heat or chemicals) to produce a preform. In an example, the tapes are placed on the surface using an automated tape placement (ATP) machine.

In some implementations, a (e.g., male) mold may be installed into any the above described preforms. The (e.g., male) mold and the preform may then be installed in a (e.g., female) mold having an inner space that is structured and arranged to provide the final, desired shape or pattern. A combination of the molds can form a curing system for forming the preform into the consolidated skate boot shell. Once the (e.g., male) mold and the preform have been properly installed in the (e.g., outer, female) mold, the preform may then be consolidated using one or more of a variety of forming processes, such as heat, pressure, compression, wet lay-up, vacuum forming, and so forth. The finished, consolidated skate boot shell may be removed from the (e.g., female) mold and the (e.g., male) mold may be removed from the inside of the consolidated skate boot shell.

In some implementations, a skate boot shell, a mating component therefor, and the like may be comprised of thermoformable (e.g., thermoplastic) materials with a softening point below 100° C. reinforced with tapes (e.g., thermoplastic fiber-reinforced tapes), such that the shape of the rigid structures of the boot may be modified and/or re-shaped by exposing the boot to temperatures below 100° C. and placing the boot directly on the foot of the consumer. When the thermoformable material is heated above its softening point, application of pressure to the boot shell may cause the materials of the tapes to translate relative to each other as the lower softening point material retains the new shape based on the applied pressure. In some implementations, the tapes may include thermoset tow-preg tapes (e.g., carbon/epoxy, fiberglass/epoxy, and so forth) and/or thermoplastic tapes (e.g., fiber-reinforced thermoplastic tapes) may be used in place of or in addition to the fibers as described herein. The thermoset and/or thermoplastic materials of the tapes may have a softening point above 100° C. The tapes may be reinforced with fibers (e.g., structural fibers).

In some implementations, a skate boot shell, a mating component therefor, and the like may be formed from tapes (e.g., thermoplastic fiber-reinforced tapes). In some implementations, the tapes may include thermoset tow-preg tapes (e.g., carbon/epoxy, fiberglass/epoxy, and so forth) and/or thermoplastic tapes (e.g., fiber-reinforced thermoplastic tapes) may be used in place of or in addition to the fibers as described herein. The thermoset and/or thermoplastic materials of the tapes may have a softening point above 100° C. The tapes may be reinforced with fibers (e.g., structural fibers).

In some implementations, a skate boot shell, a mating component therefor, and the like may be comprised of thermoformable (e.g., thermoplastic) materials with a softening point below 100° C. reinforced with fabrics (e.g., woven from fibers and/or tapes), such that the shape of the rigid structures of the boot may be modified and/or re-shaped by exposing the boot to temperatures below 100° C. and placing the boot directly on the foot of the consumer. When the thermoformable material is heated above its softening point, application of pressure to the boot shell may cause the fabrics to translate relative to each other as the lower softening point material retains the new shape based on the applied pressure. Suitable fabric may be woven from fibers (e.g., co-mingled fibers) and/or tapes (e.g., fiber-reinforced thermoplastic tapes) described herein.

In some embodiments, the fibers, tapes, and/or fabrics can be included in the skate boot shell at one or more areas or portions of the skate boot shell. The fibers, tapes, and/or fabrics may be located at a medial forefoot portion, a lateral forefoot portion, a sole portion, a lateral ankle portion, a medial ankle portion, and/or a heel portion of the skate boot shell. Further, fibers derived from the tapes and/or fabrics may be located at a medial forefoot portion, a lateral forefoot portion, a sole portion, a lateral ankle portion, a medial ankle portion, and/or a heel portion of the skate boot shell.

In some implementations, one or more layers (e.g., layers 1162, 1164, and 1166) of a skate boot shell, a mating component therefor, and the like may be manufactured according to the TFP techniques described herein. For example, the TFP techniques described at least with respect to FIGS. 9A-9F may be used to manufacture one or more of the layer(s) for a skate boot shell, a mating component therefor, and the like described herein. In some implementations, one or more layers (e.g., layers 1162, 1164, and 1166) of a skate boot shell, a mating component therefor, and the like may be manufactured according to techniques other than the TFP techniques described herein.

### Orientation (Alignment) of Fibers

Rigidity refers to the stiffness of the skate boot shell and its interaction with the human body to enable the wearer to accomplish a desired purpose. Advantageously, due to the TFP manufacturing process the rigidity of the skate boot shell may be asymmetrical and location-specific to provide different levels of rigidity on, for example, the lateral and the medial sides of the ice skate, the anterior and posterior planes of the ice skate, the forefoot and heel regions of the ice skate, and so forth.

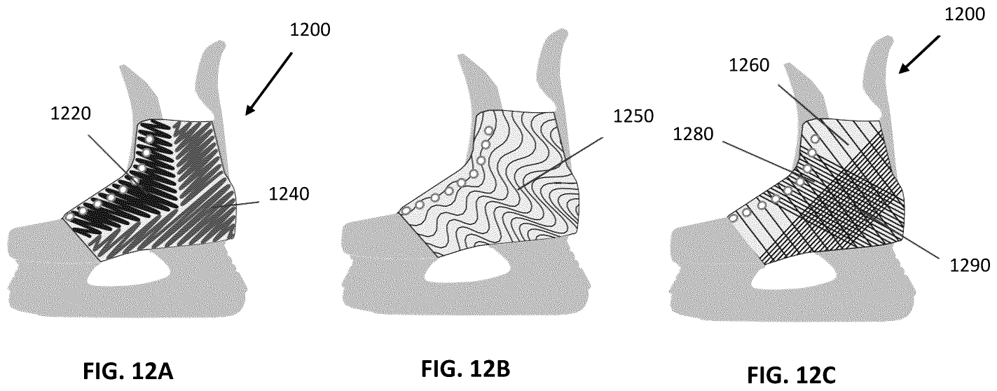

Stiffness typically includes a tradeoff with a suitable level of flexibility. One goal of some embodiments of the invention remains integrating multiple fibers having the same or different mechanical properties into the preforms 900, as well as optimizing the orientation of fibers. Indeed, in some applications, multiple fibers/material tows may be integrated into the TFP preforms, such that the multiple fibers/material tows may be localized in different areas of the preform. For example, as shown in the skate boot shell 1200 depicted in FIG. 12A, in some applications, carbon fibers 1220 may be provided in a first portion of the skate boot shell 1200 where the material properties of carbon fiber 1220 would be best utilized and glass fibers 1240 may be provided in a second portion of the skate boot shell 1200 where the material properties of the glass fiber 1240 would be best utilized.

As shown in FIG. 12B, the multiple fibers/material tows 1250 that comprise each layer may also be oriented in any direction between 0 and 180 degrees, and the orientation of any successive layer is not limited by the orientation of the previous one with respect to one another. Advantageously, the preferred arrangement of the multiple fibers/material tows enables manufacture of a skate boot shell that may be stiffer in a latitudinal direction than a longitudinal direction. Furthermore, the preform may include any density/concentration (areal weight, i.e., mass per unit area such as grams per square meter). Additionally, the orientation of a single tow may change over the surface to meet structural requirements. For example, in one implementation, the tow may travel in a circular path such as to reinforce an eyelet or other aperture.

In certain embodiments the path of one or more fiber reinforcements may remain linear over the length of the fiber reinforcement. In alternative embodiments, one or more fiber reinforcements may follow a curved path having a constant or varying curvature, may include abrupt and or gradually transitioning changes in direction, and/or a combination thereof. In certain embodiments, adjacent fiber reinforcements within a region of the shell may follow parallel or substantially parallel paths. Alternatively, one or more adjacent fibers within a defined region may converge and/or diverge with adjacent fibers to increase or decrease the density of fibers within a localized region and/or adjust the angle of maximal stiffness from one location to another.

As shown, for example, in FIGS. 3 and 4, the structural preform may comprise a plurality of discrete, separate, fiber reinforcements that are located and oriented in accordance with the structural requirements of the skate. In an alternative embodiment, the support in a specific region of the shell may be provided by a single, continuous fiber that is arranged to provide a plurality of adjacent fiber reinforcements that are located and oriented in accordance with the structural requirements of the skate. In a further embodiment, as shown for example in FIG. 12A, the structural preforms may comprise different extended continuous fibers providing structural properties to different regions of the shell. By allowing for the orientation and density of adjacent fibers within one or more region of the shell to change, either abruptly or gradually, from a first location to a second location within that region, the invention described herein provides an efficient method of manufacture and skate structure that allows for a highly adaptable and customizable distribution of support elements over any portion of the skate which may be adapted to beneficially support any required combination of stiffness, flexibility, protection, and performance characteristics required for a particular design and/or athlete.

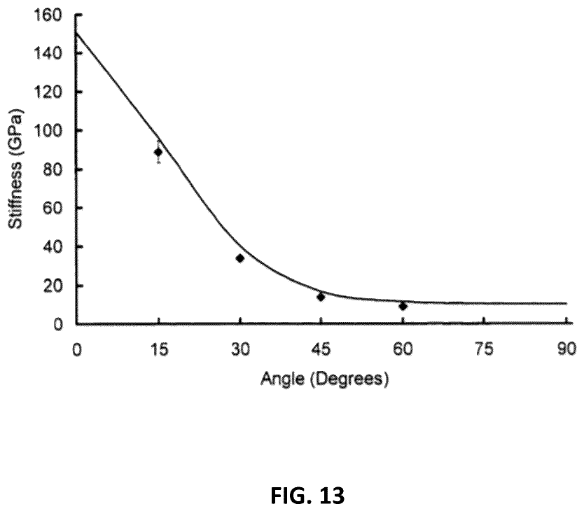

The structural advantage of strategic fiber alignment made possible by TFP is shown for carbon fibers in the graph in FIG. 13. Advantageously, the tensile strength (or stiffness) loss of the carbon fiber (as measured by Young's modulus (E)) when the fiber angle is oriented 30 degrees from a neutral plane is about 72 percent, whereas the stiffness loss is 87 percent when the fiber angle is oriented 45 degree from a neutral plane. Thus, TFP provides the unprecedented opportunity to control the orientation of individual fibers—and hence the stiffness at discrete locations of the skate boot shell—in a manner not possible using uni- or bidirectional sheets of parallel fibers, as practiced in the prior art. Additionally, TFP orients the fibers in a straight, single plane unlike a traditional woven fabric where fiber overlap generates a zig-zag orientation out-of-plane and thus loss of mechanical properties.

### Orientation of Reinforcement

Referring to FIG. 3, an illustrative embodiment of reinforcement 320 for a mating component for a preform 300 for a skate boot shell is shown. In some implementations, (e.g., horizontal or substantially horizontal) reinforcement 320 may be provided in the heel portion or region 350 of the preform 300 of the skate boot shell to provide, inter alia, additional support to the ankle and the ankle area of the wearer. In some cases, the heel portion or region 350 can include an upper Achilles tendon region of the skate boot shell.

Referring to FIG. 4, an illustrative embodiment of reinforcement 400 for a mating component for a preform 300 for a skate boot shell is shown. In some implementations, (e.g., vertical or substantially vertical) reinforcement 400 may be provided in the lower boot area 450 of the preform 300 of the skate boot shell to provide, inter alia, lateral stiffness for the wearer's foot.

Referring to FIG. 6, an illustrative embodiment of reinforcement for the outsole preform 600 for a skate boot shell is shown. In some implementations, reinforcements 620, 640 that are adapted to be oriented about 45 degree from a neutral plane may be provided in the outsole preform 600 of the skate boot shell to provide, inter alia, torsional stiffness to the lower boot. Those of ordinary skill in the art can appreciate that torsional stiffness to the lower boot may also be added if the reinforcements 620, 640 are adapted to be oriented about 30-60 degrees from a neutral plane.

Referring to FIG. 8, an illustrative embodiment of a preform 800 for a composite skate boot shell and outsole is shown. The preform 800 may include the preform 300 and the outsole preform 600 joined at a lower heel and/or under heel area 850 adjacent to a heel region 540.

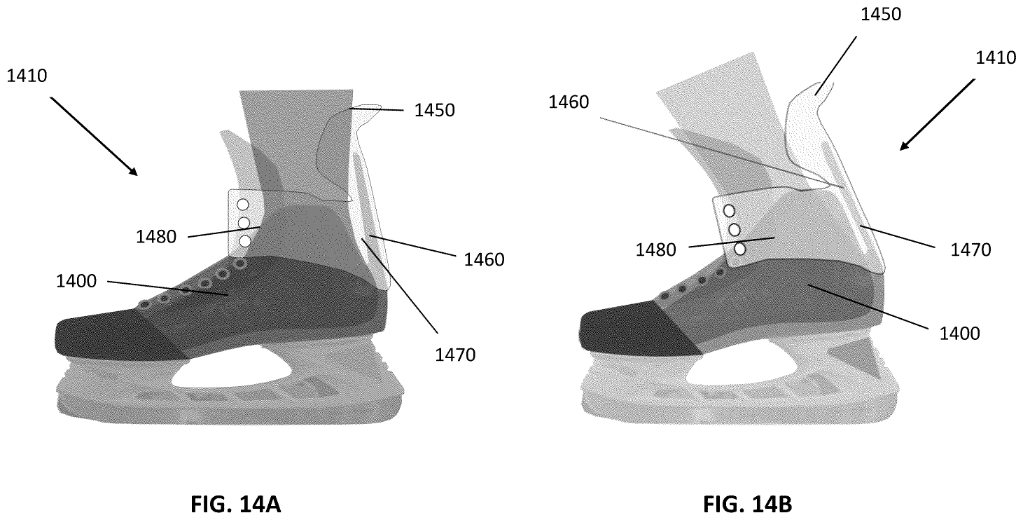

Referring to FIGS. 14A and 14B, a desired characteristic of embodiments of the present invention is shown. In some applications, an articulated cuff portion 1410 includes a tendon guard portion 1450 and an ankle guard portion 1480, produced from a first material which has a first stiffness. Preferably, the skate boot shell 1400, produced from a second material having a second stiffness, is structured and arranged to include a (e.g., cantilevered) flex rail 1460, produced from the same second material but having a stiffness different than the first and second stiffnesses, that is separated from the skate boot shell 1400 by a gap 1470. Advantageously, the cuff portion 1410 provides a desired vertical (i.e., in the coronal plane) stiffness (per FIG. 3) without inhibiting dorsiflection movement while providing the wearer with an energy return when the flex rail 1460 is compressed against the skate boot shell 1400, decreasing the gap distance separating the two.

### Length and Thickness of Fibers

In addition to integrating multiple fibers/material tows into the preform, TFP preforms may also be embroidered to variable thicknesses at discrete locations on the skate boot shell 1200. For example, as shown in FIG. 12C, a single layer roving thickness 1260 of the preform may be provided in a first portion of the skate boot shell 1200, a double layer roving thickness 1280 of the preform may be provided in a second portion of the skate boot shell 1200, a triple layer roving thickness 1290 of the preform may be provided in a third portion of the skate boot shell 1200, and so forth.

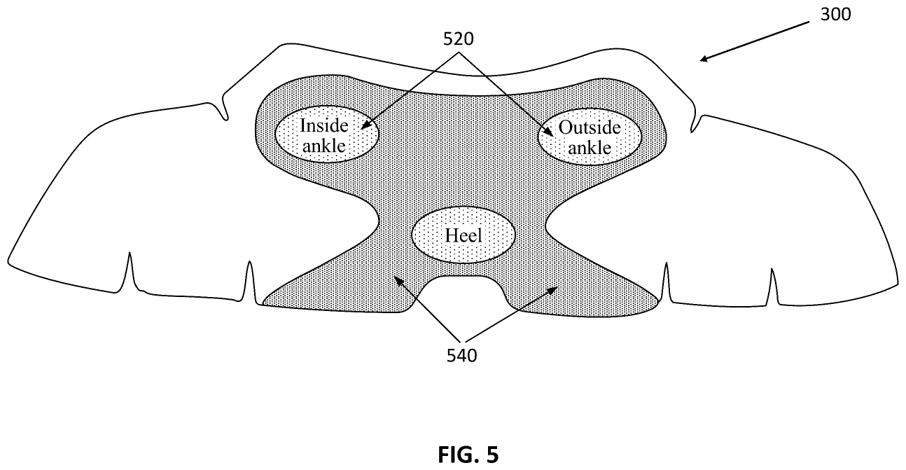

As shown in FIG. 5, additional layers of fibers may be provided in the inside and outside ankle regions 520 to provide additional thickness for lateral stiffness and protection for the wearer's ankles. Additional layers of fibers may also be provided in the heel region 540 to provide additional stiffness and reinforcement in a highly stressed area (i.e., due to the presence of heel rivets for the ice skate). In some cases, the heel region 540 can include an upper Achilles tendon region.

As shown in FIG. 7, additional layers of fibers may be provided on the lateral and medial sides of the outsole 600, on a peripheral surface (e.g., peripheral edge surface) in the forefoot 720 and heel regions 740 of the outsole 600. Additional layers of fibers provide additional reinforcement in a highly stressed area (i.e., due to the presence of rivets holes in the ice skate).

Fiber reinforcement may include short and long fiber reinforcement. Long fibers typically span across the surface of the part and are often straight (i.e., unidirectional or woven into the fabric) and tensioned; however, disadvantageously, they may lose mechanical strength when randomly placed in mats. Short fibers are usually randomly placed and between about 1 mm and about 30 mm in length.

### Electrically-Conductive Fibers

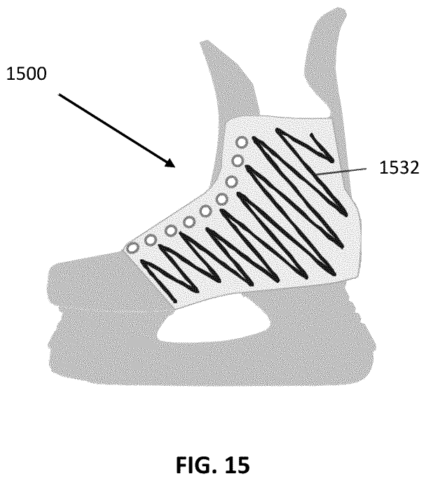

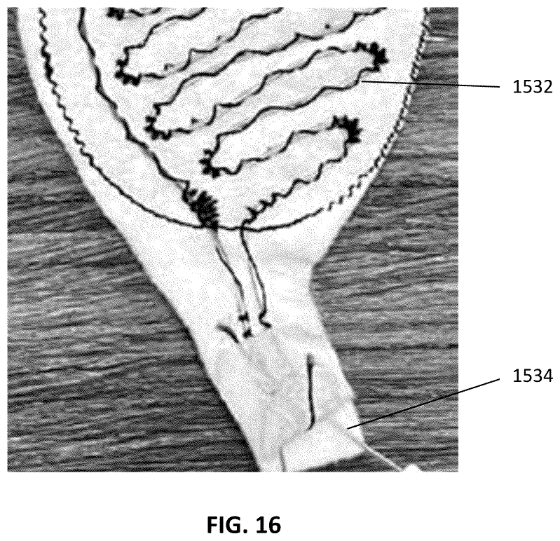

Optionally, as shown in FIGS. 15 and 16, in some implementations, a (e.g., electrically) conductive wire or filament 1532 (e.g., a copper wire or filament, of the like) may integrated into the preform. The conductive wire or filament 1532 is configured to generate heat when current is run through the wire or filament 1532. Advantageously, once the preform has been compressed, the conductive wire or filament 1532 may be electrically coupled to a power source (e.g., using a female terminal 1534 integrated into the conductive wire or filament 1532). The current passing through the conductive wire or filament 1532 heats the composite skate boot shell 1500 to a softening temperature, enabling the finished product to be thermoformed to a discrete user's foot. In some variations, in lieu of or in addition to integrating a conductive wire or filament 1532 into the preform, the skate boot shell 1500 may be manufactured using a low Tg (e.g., less than 110° C.) thermoset resin for thermoforming.

In some cases, the entire boot or shell is comprised of thermoformable materials. In other cases, inserts comprised of thermoformable materials are placed strategically to allow customization of the boot shape in those areas. In either case, the current carrying wires may be used to deliver some or all of the heat required to achieve the desired thermoformability of the boot.

The advantage to using current carrying wires is that heat can be generated locally and restricted to strategic areas, thus isolating heat-sensitive materials located in other areas of the boot. In some cases, the heat required to thermoform strategic elements of the boot may be higher than the maximum working temperatures of materials used for other components. Thus, thermoformability is achieved without thermally degrading and/or damaging other components of the skate.

A second advantage to using current carrying wires is that heat can be generated within the outer boot and/or shell of the boot without exposing the wearer's foot to elevated and/or dangerous temperatures. In this case, the temperature of the inner boot may remain below 80° C.

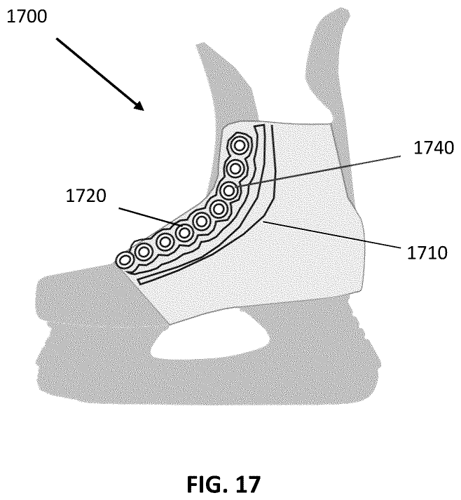

As shown in FIG. 17, a preferred fiber orientation 1710 may also be used to define, create, and/or reinforce eyelets 1720, 1740 in the preform of the composite skate shell 1700.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Although the present invention has been described herein in detail in relation to one or more preferred embodiments, it is to be understood that this disclosure is only illustrative and exemplary of embodiments of the present invention and is made merely for the purpose of providing a full and enabling disclosure of embodiments of the invention. The foregoing disclosure is not intended to be construed to limit the present invention or otherwise exclude any such other embodiments, adaptations, variations, modifications or equivalent arrangements; embodiments of the present invention being limited only by the claims appended hereto and the equivalents thereof.

What we claim is:

1. A method of manufacturing a portion of a boot shell for an ice skate, the method comprising:
preparing a monolithic, two-dimensional pattern of the boot shell;
positioning the monolithic, two-dimensional pattern into a three-dimensional preform of the boot shell;
installing the three-dimensional preform in a mold; and
consolidating the three-dimensional preform in the mold to produce the portion of the boot shell.

2. The method of claim 1, wherein the portion of the boot shell comprises a mating component therefor.

3. The method of claim 1, wherein preparing the monolithic, two-dimensional pattern comprises tailored fiber placement comprising placing a plurality of fibers at discrete locations of the monolithic, two-dimensional pattern, the fibers being oriented in two or more different predetermined orientations.

4. (canceled)

5. The method of claim 3, wherein, in an ankle portion of the boot shell, the fibers are oriented horizontally or substantially horizontally to provide lateral support to an ankle of a wearer and, in a lower boot portion of the boot shell, the fibers are oriented vertically or substantially vertically to provide lateral stiffness to a foot of the wearer.

6. The method of claim 3, wherein, in an outsole of the boot shell, the fibers are oriented in a plus or minus 45-degree hatch pattern to provide torsional stiffness.

7. The method of claim 3, wherein the tailored fiber placement comprises:
placing a material sheet at a discrete location of the monolithic, two-dimensional pattern; and
placing a plurality of fibers at discrete locations of the monolithic, two-dimensional pattern, wherein the plurality of fibers couple the material sheet to the monolithic, two-dimensional pattern.

8. The method of claim 3, wherein the tailored fiber placement comprises placing a plurality of fibers at discrete locations of the monolithic, two-dimensional pattern, the fibers being added to provide a greater thickness in two or more different predetermined orientations.

9-12. (canceled)

13. The method of claim 1, wherein the monolithic, two-dimensional pattern comprises an asymmetric, non-orthotropic structural material.

14. (canceled)

15. The method of claim 1, wherein the monolithic, two-dimensional pattern comprises a plurality of tabs.

16-17. (canceled)

18. The method of claim 1, wherein installing the three-dimensional preform in the mold comprises:
placing an inner mold portion within the three-dimensional preform; and
placing the inner mold portion and the three-dimensional preform in an outer mold portion.

19-28. (canceled)

29. A method of manufacturing a portion of a boot shell for an ice skate, the method comprising:
preparing a two-dimensional pattern of the boot shell with fiber reinforcement material;
positioning the two-dimensional pattern onto a hollow, three-dimensional preform of the boot shell comprising a thermoformable material, wherein the thermoformable material is rigid at room temperature and has a softening point above 40° C.;
installing the three-dimensional preform in a mold; and
consolidating the three-dimensional preform in the mold to produce the portion of the boot shell.

30-35. (canceled)

36. An article of footwear for use in ice skating, the article of footwear comprising:
a boot shell structured and arranged to accommodate a wearer's foot and having a medial forefoot portion, a lateral forefoot portion, a sole portion, a lateral ankle portion, a medial ankle portion, and a heel portion, the boot shell further comprising (i) a first thermoformable material having a softening point between 40° C. and 100° C., and (ii) a plurality of fibers, wherein the fibers are at least one of adjacent to or integrated within the first thermoformable material.

37-39. (canceled)

40. The article of footwear as recited in claim 36, wherein the first thermoformable material is interleafed between a first exterior layer of the boot shell and a second exterior layer of the boot shell, wherein both the first and second exterior layers comprise a material different from the first thermoformable material.

41. The article of footwear as recited in claim 36, wherein the plurality of fibers are configured to increase a flexural modulus of the first thermoformable material.

42. The article of footwear as recited in claim 36, wherein the plurality of fibers comprise at least one of a plurality of raw fibers or a plurality of co-mingled fibers.

43. The article of footwear as recited in claim 36, wherein the plurality of fibers are positioned at discrete locations of the boot shell, the plurality of fibers being oriented in two or more different predetermined orientations.

44. The article of footwear as recited in claim 36, wherein the plurality of fibers are positioned at discrete locations of the boot shell, the plurality of fibers providing a greater thickness in two or more different predetermined orientations.

45. The article of footwear as recited in claim 36, wherein a current carrying material is embedded within the boot shell adjacent to the first thermoformable material.

46-47. (canceled)

48. The article of footwear as recited in claim 36, wherein the boot shell further comprises a second thermoformable material having a softening point above 100° C., wherein the second thermoformable material comprises the plurality of fibers.

49-51. (canceled)

52. The article of footwear as recited in claim 48, wherein a current carrying material is embedded within the boot shell adjacent to the second thermoformable material.

53. (canceled)
